(19) United States
(12) Patent Application Publication
(10) Pub. No.: US 2011/0147579 A1
(43) Pub. Date: Jun. 23, 2011

(54) PARTICULATE MONITORING

(75) Inventor: Charles E. Wickersham, JR., Columbus, OH (US)

(73) Assignee: First Solar, Inc., Perrysburg, OH (US)

(21) Appl. No.: 12/964,438

(22) Filed: Dec. 9, 2010

Related U.S. Application Data
(60) Provisional application No. 61/287,882, filed on Dec. 18, 2009.

(51) Int. Cl. B01D 59/44; G01J 3/443; H01J 49/00

(52) U.S. Cl. 250/282; 356/311; 250/281

(57) ABSTRACT

A method for monitoring a quantity of a particle in a sample of air may include heating a particle to form a vapor; detecting the particle; measuring a change in quantity of the particle; and indicating the change in quantity.

### CLAIM FOR PRIORITY

This application claims priority under 35 U.S.C. §119(e) to U.S. Provisional Patent Application Ser. No. 61/287,882 filed on Dec. 18, 2009, which is hereby incorporated by reference.

### TECHNICAL FIELD

The present invention relates to photovoltaic modules and methods of production.

### BACKGROUND

The manufacture of photovoltaic modules can include vaporizing particles of material to be deposited. Current methods of monitoring the amount of material in the vapor can take many hours to several days to obtain results and can provide only an average value for the concentration. A need exists for an analytical tool that is capable of measuring the particulate density of the material to be deposited in air in real time.

### DESCRIPTION OF DRAWINGS

FIG. 1 is a schematic of a system for monitoring air quality.

### DETAILED DESCRIPTION

Manufacture of photovoltaic modules can include depositing vaporized materials, for example on a substrate. Cadmium-containing materials are examples of materials that can be vaporized and deposited during photovoltaic module manufacture. Methods of monitoring air quality to control air levels of materials to be deposited often entail passing air through one or more filters, and obtaining an average value concentration of a particle of the material (e.g., a metal) present in the air. Numerous methods may be used to determine the average value concentration, including, for example, inductively-coupled plasma spectroscopy, wavelength dispersive X-ray spectroscopy, and particle-induced X-ray emission. These filter-based processes can require considerable time, up to eight hours, for example, to pass air through the filters alone. It would be desirable to monitor the quantity of a particle such as metal in a sample of air in real time.

A method for monitoring a quantity of a particle in a sample of air can include sampling a first air sample including a first particle. The method can include heating the first air sample to form a first vapor from the first particle. The first vapor can include a metal. The method can include measuring a first amount of metal in the first vapor. The method can include sampling a second air sample including a second particle. The method can include heating the second air sample to form a second vapor from the second particle. The second vapor can include the metal. The method can include measuring a second amount of metal in the second vapor. The method can include comparing the first amount of the metal and the second amount of the metal.

The metal can include cadmium. The measuring can include passing one of the first and second vapors through a mass spectrometer. The measuring can include determining a mass-to-charge ratio. The heating can include positioning one of the first and second particles proximate to a heated material. The heated material can include silicon carbide. The heated material can be porous. The heating can include physically contacting one of the first and second particles with the heated material.

A system for monitoring the quantity of particle in an air sample can include an air sampler configured to capture a particle. The system can include a vaporizer configured to form a vapor from the particle. The vapor can include a metal. The system can include a monitoring device proximate to the vaporizer to indicate a quantity of metal in the vapor. The vaporizer can include a heated material. The heated material can include silicon carbide. The heated material can be porous. The monitoring device can include a mass spectrometer. The monitoring device can include a quadrapole. The system can include a threshold indicator configured to signal whether the sample includes a quantity of metal above a threshold. The threshold indicator can include a microprocessor in communication with the monitoring device.

A method for monitoring a quantity of cadmium in a sample of air can include sampling a first air sample including a first amount of cadmium. The method can include heating the first air sample to vaporize the first amount of cadmium by contacting the first air sample with a silicon carbide heating element. The method can include passing the first amount of vaporized cadmium through a mass spectrometer to measure the first amount of cadmium. The method can include sampling a second air sample including a second amount of cadmium. The method can include heating the second air sample to form a second amount of cadmium by contacting the second air sample with the silicon carbide heating element. The method can include passing the second amount of vaporized cadmium through the mass spectrometer to measure the second amount of cadmium. The method can include comparing the first amount of cadmium to the second amount of cadmium.

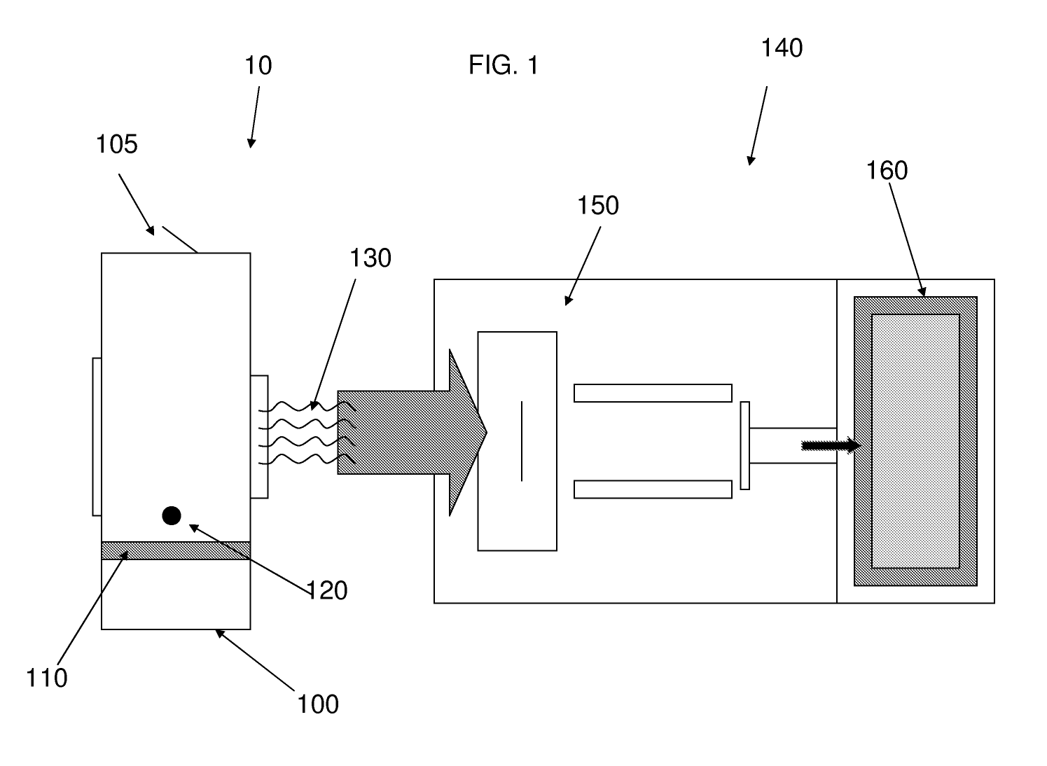

Referring to FIG. 1, by way of example, a system 10 for monitoring the amount of a particle in a sample of air may include a vaporizer 100. Vaporizer 100 may include any suitable apparatus or equipment for vaporizing a particle in air. Vaporizer 100 can include air sampler 105. Air sampler 105 can include an opening in vaporizer 100. Air sampler 105 can be configured to capture a sample such as a particle. The particle can be placed in air sampler 105.

Vaporizer 100 may include a heated material 110, capable of vaporizing a particle, or a substance containing the particle, to be monitored. Heated material 110 may include any suitable material, including a silicon carbonate. Heated material 110 may be porous. For example, heated material 110 may include a porous silicon carbonate. The air sample can include particle 120. The air sample in air sampler 105 can be vaporized to form a vapor 130. The vapor 130 can be formed by heating the air sample. The vapor can include a metal from the particle 120. A particle 120 from a sample of air, may contact heated material 110. Particle 120 may include any element, molecule, and/or chemical composition. Particle 120 can include metal, which can be included in vapor 130. The metal can include cadmium.

Particle 120 may physically contact heated material 110. Heated material 110 may have a higher temperature than particle 120, such that upon establishing contact with heated element 110, particle 120 may vaporize into vapor 130, which can include a metal from particle 120. Following vaporization, vapor 130 may enter monitoring device 140. Monitoring device 140 may be configured to analyze vapor 130 to detect a quantity of any element, composition, or molecule. For example, monitoring device 140 can analyze vapor 130 to detect any of a metal contained in the vapor, for example, cadmium. Any change in the amount of vapor 130 including a metal can be measured. The change in the amount of metal can be indicated.

Monitoring device 140 may include and/or utilize a variety of methods and devices to analyze vapor 130. Monitoring device 140 may include a mass analyzer 150. Mass analyzer 150 may include any suitable mass spectroscopy device, including, for example, one or more mass spectrometers. Monitoring device 140 can include any other suitable device for analyzing vapor 130. For example, monitoring device 140 can include an atomic absorption spectrometer. Vapor 130 may enter monitoring device 140 through mass analyzer 150 for part are all of the analysis of vapor 130. Measuring the amount of metal in vapor 130 can include passing vapor 130 through a mass spectrometer. Measuring the amount of metal in vapor 130 can include determining a mass-to-charge ratio for the air sample. Any suitable means can be used to maintain vapor 130 in vapor form. For example, a portion of monitoring device 140 can be heated to prevent vapor 130 from condensing or plating on a surface of monitoring device 140. In other embodiments, a reactive element can be added to vapor 130 that could react with a component of vapor 130 (e.g., cadmium) to form a gaseous species which could then be detected in monitoring device 140 (e.g., a mass spectrometer). For example, a hydrogen-containing gas can be added to form a gas species such as a cadmium telluride hydride, or any suitable gaseous species including a component of vapor 130.

Monitoring device 140 can include means to detect the quantity or amount of an element, composition, or molecule, for example, a metal such as cadmium and tellurium and other materials such as sulfur and chlorine. The means may include a current collector, such as a wire, to detect the successful passage of ions through a quadrapole or mass spectrometer. Monitoring device 140 may include a means to compare the collected current to a threshold current representative of a maximum quantity of an element, composition, or molecule being observed, such as a metal, for example, cadmium.

Monitoring device 140 may output a signal to indicate that a threshold for a predefined element, composition, or molecule has been reached. Monitoring device 140 can employ any suitable means to perform the comparison and output steps, including, for example, via a microprocessor 160. Microprocessor 160 can receive information via a data interface from mass analyzer 150 regarding the quantity of a predefined element, and compare the quantity information to a threshold, to determine whether to output a signal. The output signal may indicate that a certain level of a predefined element is present in the monitored air sample. For example, microprocessor 160, in conjunction with mass analyzer 150, may determine that a certain amount of cadmium is present in the sample of air monitored. Monitoring device 140 can thus determine whether the quantity of cadmium in a given sample of air has exceeded a defined amount or quantity for any environment, including, for example, a production environment for photovoltaic modules.

The embodiments described above are offered by way of illustration and example. It should be understood that the examples provided above may be altered in certain respects and still remain within the scope of the claims. It should be appreciated that while the invention has been described with reference to the above preferred embodiments, other embodiments are within the scope of the claims.

What is claimed is:

1. A method for monitoring a quantity of a particle in a sample of air comprising the step of:
sampling a first air sample including a first particle;
heating the first air sample to form a first vapor from the first particle, wherein the first vapor comprises a metal;
measuring a first amount metal in the first vapor;
sampling a second air sample including a second particle;
heating the second air sample to form a second vapor from the second particle, wherein the second vapor comprises the metal;
measuring a second amount of metal in the second vapor; and
comparing the first amount and the second amount.

2. The method of claim 1, wherein the metal is cadmium.

3. The method of claim 1, wherein the measuring comprises passing one of the first and second vapors through a mass spectrometer.

4. The method of claim 1, wherein the measuring comprises determining a mass-to-charge ratio.

5. The method of claim 1, wherein the heating comprises positioning one of the first and second particles proximate to a heated material.

6. The method of claim 5, wherein the heated material comprises a silicon carbide.

7. The method of claim 5, wherein the heated material is porous.

8. The method of claim 5, wherein the heating comprises physically contacting one of the first and second particles with the heated material.

9. A system for monitoring the quantity of a particle, the system comprising:
an air sampler configured to capture a particle;
a vaporizer configured to form a vapor from the particle, wherein the vapor comprises a metal; and
a monitoring device proximate to the vaporizer to indicate a quantity of metal in the vapor.

10. The system of claim 9, wherein the vaporizer comprises a heated material.

11. The system of claim 10, wherein the heated material comprises a silicon carbide.

12. The system of claim 10, wherein the heated material is porous.

13. The system of claim 9, wherein the monitoring device comprises a mass spectrometer.

14. The system of claim 9, further comprising a threshold indicator configured to signal whether the sample includes a quantity of metal above a threshold.

15. The system of claim 13, wherein the threshold indicator comprises a microprocessor in communication with the monitoring device.

16. A method for monitoring a quantity of cadmium in a sample of air comprising the steps of:
sampling a first air sample including a first amount of cadmium;
heating the first air sample to vaporize the first amount of cadmium by contacting the first air sample with a silicon carbide heating element;
passing the first amount of vaporized cadmium through a mass spectrometer to measure the first amount of cadmium;
sampling a second air sample including a second amount of cadmium;
heating the second air sample to form a second amount of cadmium by contacting the second air sample with the silicon carbide heating element;
passing the second amount of vaporized cadmium through the mass spectrometer to measure the second amount of cadmium; and
comparing the first amount of cadmium to the second amount of cadmium.
